(19) United States
(12) Patent Application Publication
(10) Pub. No.: US 2013/0190181 A1
(43) Pub. Date: Jul. 25, 2013

(54) SYNERGISTIC BLENDS OF (ALKYL) NAPHTHALENE FORMALDEHYDE CONDENSATE SULFONATES AND LIGNOSULFONATES USEFUL IN AGROCHEMICAL FORMULATIONS

(71) Applicant: AKZO NOBEL N.V., Arnhem (NL)

(72) Inventor: Mark ALEXANDER, Forth Worth, TX (US)

(73) Assignee: AKZO NOBEL N.V., Arnhem (NL)

(21) Appl. No.: 13/793,181

(22) Filed: Mar. 11, 2013

Related U.S. Application Data
(62) Division of application No. 11/916,310, filed on Dec. 3, 2007.
(60) Provisional application No. 60/686,779, filed on Jun. 2, 2005.

(51) Int. Cl. A01N 25/12

(52) U.S. Cl. CPC A01N 25/12
USPC 504/367

(57) ABSTRACT

The invention generally relates to a synergistic co-spray dried blend of (alkyl) naphthalene formaldehyde condensate sulfonates and lignosulfonates. This co-spray dried blend is useful as a dispersant in useful in agrochemical formulations.

This application is a division of U.S. Non-Provisional Patent Application Ser. No. 11/916,310, filed Dec. 3, 2007, now pending, which is a 371 of PCT/EP2006/062649, filed May 29, 2006, which, in turn, claims priority of U.S. Provisional Application Ser. No. 60/686,779, filed Jun. 2, 2005, the entire contents of which patent applications are hereby incorporated by reference.

### FIELD OF THE INVENTION

The present invention generally relates to a synergistic blend of (alkyl) naphthalene formaldehyde condensate sulfonates and lignosulfonates useful in agrochemical formulations.

### BACKGROUND OF THE INVENTION

Lignosulfonates and naphthalene condensate sulfonates are both used as dispersants in agricultural formulations, specifically suspension concentrates, suspoemulsions, water dispersible granules and wettable powders. Typically they are used alone in a formulation, but there are instances where they are used together in order to improve the physical stability and/or dilution performance of the finished product. When used together, the manufacturer will combine the individual liquids or powders into the formulation during manufacturing.

The present inventors have discovered an improved blend of lignosulfonates and naphthalene condensate sulfonates. More particularly, it has been discovered that the performance of lignin sulfonates plus naphthalene condensate sulfonates is increased when solutions of the two are blended and co-spray dried instead of blended together as individual powders, or added as individual solutions to the formulated product.

### SUMMARY OF THE INVENTION

The invention generally relates to a synergistic blend of (alkyl) naphthalene formaldehyde condensate sulfonates and lignosulfonates useful in agrochemical formulations. More particularly, the invention relates to a synergistic co-spray dried blend lignosulfonates and naphthalene condensate sulfonates.

### DETAILED DESCRIPTION OF THE INVENTION

The present invention relates to an improved dispersing agent composition useful in the agricultural industry. The dispersing agent composition of the present invention comprises a free-flowing powder of a blend of a) at least one lignin sulfonate, and b) at least one naphthalene condensate sulfonate. The free flowing powder of the invention is obtained by blending an aqueous solution of component a) and b), followed by a drying step. Drying can be accomplished by various means, including evaporation, freeze-drying, spray drying and the like. In one embodiment, the drying is accomplished in a (co-)spray drying step.

The present inventors have found that the performance of lignin sulfonates plus naphthalene condensate sulfonates is increased when solutions of the two are blended and dried, such as by spray-drying, instead of blended together as individual dry powders, or added as individual solutions to the formulated product.

Exemplary components a) are water-soluble salts of lignin sulfonate, e.g., the sodium, potassium, magnesium, calcium or ammonium salts of lignin sulfonate are preferably employed as component a) of the synergistic blend disclosed herein. The sodium salt of lignin sulfonate is preferred for use herein. Any commercially available lignin sulfonate salt which does not contain added surfactant, may be conveniently employed herein. Commercially available lignin sulfonate emulsifiers include, but are not limited to: Reax.®, LTS, LTK and LTM, respectively, the potassium, magnesium and sodium salts of lignosulfonate (50% aqueous solutions), Scott Paper Co., Forest Chemical Products; Marasperse CR.® and Marasperse CBOS-3.®, sodium lignosulfonate, and Marasperse C21.®, calcium sulfonate, Reed Lignin Co., Polyfon O.®, Polyfon T.®, Reax 88B.®, Reax 85B.®, sodium salts of lignin sulfonate, Westvaco Polychemicals.

Component b) is an alkyl naphthalene formaldehyde condensate sulfonate of the formula:

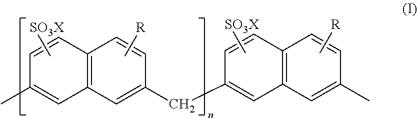

wherein each R is independently hydrogen, a C₁₋₃₀ straight or branched chain alkyl or alkenyl group, preferably a C₁₋₄ alkyl group; and each X is independently hydrogen, an alkali metal, an alkaline earth metal, ammonium, a mono-, di-, or tri-C₁₋₄ alkyl ammonium, or a mono-, di-or tri-C₁₋₄ hydroxyalkyl ammonium moiety. In the above formula I, it is understood that the R groups can be present in any position on the naphthalene nucleus. The n groups show the repetition of the monomer units. In most embodiments, each n is on average from 1-25.

The alkyl naphthalene condensate sulfonates of formula I are preferably manufactured by the process of U.S. Pat. No. 5,110,981 to Milstein, which is incorporated herein by reference. As stated in this patent, the alkyl naphthalene condensate sulfonates are usually obtained in the form of mixtures, containing both mono- and di-alkyl sulfonates, as well as small quantities of unreacted naphthalene and/or unsulfonated alkyl naphthalenes which will not interfere with their use in the practice of the present invention.

In general, components a) and b) are mixed together at 100% active concentrations in the following ratio 5:95 to 95:5, in another embodiment 10:90 to 90:10, in another embodiment 15:85 to 85:15, in another embodiment 25:75 to 75:25 and in still another embodiment of 50:50. Thereafter, aqueous solutions of each are prepared for use in preparing the free flowing powder of the invention.

Each of components a) and b) are typically obtained as 45% solids solutions from the respective synthesis routes. Once obtained, aqueous solutions of a) and b) are mixed together to form an aqueous blend of a) and b). Alternatively, a dry, or semi-dry powders of each of components a) and b) can be utilized. Said (semi)dry powders could be blended either before and/or after the addition of water, with the objective of obtaining an aqueous blend of a) and b).

The quantity of solution a) and b) are blended together to give the desired ratio, such as 15:85 and 85:15, based on the percent solids present in solution a) and b). Either solution a) or b) would be charged into the appropriate tank and heated to a target temperature to facilitate homogeneity, typically between 50° C. and 70° C. Once the target temperature has been achieved the other solution is added to the tank. That mixture is mixed until homogenous. Homogeneity should be verified via analysis before the solution is dried.

Thereafter, the aqueous blend of a) and b) is dried in order to get the dry free-flowing powder of the invention. In one embodiment, the liquid blend is dried using a Co-current type spray drier. Suitably it is a top fed, atomized spray drier. The inlet temperature on the drier ranges from 300° F. to 500° F. and the outlet temperature ranges between 200° F. and 270° F. The liquid if fed into the drier at a rate of between 10 and 20 gallons per minute.

The dry blends of the alkyl naphthalene condensate sulfonates and lignosulfonates are used as dispersants for wettable powders, water dispersible granules, suspension concentrates and suspoemulsions. Generally the blend is used with either non-ionic or an-ionic surfactant(s) acting as wetting agent or formulation stabilizer. The blends are used in suspension concentrates and suspoemulsions at a concentration range of 1.0 to 20% wt of the formulation, preferably 1.0 to 12.5% wt. Ideal embodiments utilize between 2.0 and 7.5% wt. In water dispersible granules and wettable powders, the use rate can range between 1.0 and 25% wt, preferably 2.0 to 15% wt but most desired between 2.5 and 10% wt.

The dry blends of the present invention can be used to disperse any, and all, insecticides, herbicides, fungicides and plant growth regulators that have a water solubility of less than 1000 ppm and a melting point of greater than 50° C. The most preferred properties would be a water solubility of less than 400 ppm and a glass transition temperature of 40° C. or higher.

The invention will now be illustrated by the following non-limiting example.

### EXAMPLE

Two Atrazine suspension concentrates were produced; one using Morwet D-425 plus lignosulfonate, made by dry blending the two dry products, and the second used a Morwet+lignin powder wherein aqueous solutions of each were prepared, mixed, and co-spray dried. The following recipe was used to make the suspension concentrates:

| | |
|---|---|
| Atrazine | 43.0% wt |
| Dispersant blend | 2.5% wt |
| Water | 54.5% wt |

The technical was dry milled to an average particle size of 5 microns, so the finished suspension concentrates were not wet milled. The dispersant blend was added to the water and mixed until homogenous. The technical was then added and dispersed using high shear. Shearing continued until all of the technical was wetted and dispersed. The suspensibility of the suspension concentrates was measured using CIPAC method MT161.

The suspensibility of the two suspension concentrates was measured, and the results were:

| | 345 ppm water | 1000 ppm water |
|---|---|---|
| Dispersant | % suspensibility | % suspensibility |
| Calcium lignin: D-425 (mix) | 59.8 | 14.9 |
| Calcium lignin: D-425 (codry) | 83.4 | 49.8 |

The suspensibility of the suspension concentrate that contained the co-dried dispersant blend of the invention was substantially higher in 345 ppm and 1000 ppm water when compared to the suspension that contained the dry blend of dispersants according to the prior art. This result is both surprising and unexpected.

1. A process for preparing a dispersing agent composition in the form of a free flowing powder, the process comprises the steps of:
a. blending a solution of at least one lignin sulfonate, and at least one alkyl naphthalene condensate sulfonate; and
b. spray drying the blended solution, wherein said dispersing agent composition has a % suspensibility of at least 83% based on a 43 wt % Atrazine suspension concentrate containing 345 ppm water, measured according to CIPAC method MT161.

2. The process of claim 1 wherein said at least one lignin sulfonate is a water-soluble salt of lignin sulfonate.

3. The process of claim 2 wherein said water-soluble salt of lignin sulfonate is the sodium, potassium, magnesium, calcium or ammonium salt of lignin sulfonate.

4. The process of claim 1 wherein said at least one alkyl naphthalene condensate sulfonate has the structure: 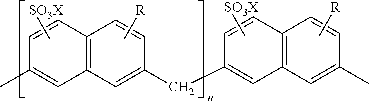
wherein each R is independently a C₁₋₃₀ straight or branched chain alkyl, or alkenyl group; each X is independently hydrogen, an alkali metal, an alkaline earth metal, ammonium, a mono-, di-, or tri-C₁₋₄ alkyl ammonium, or a mono-, di-or tri-C₁₋₄ hydroxyalkyl ammonium moiety, and n is from 1-25

5. The process of claim 1 wherein each R is independently a C₁₋₄ alkyl group.

6. The process of claim 1 wherein the ratio of lignin sulfonate to naphthalene formaldehyde condensate sulfonate is in the range of from about 5:95 to 95:5 at 100% actives concentration.

7. The process of claim 6 wherein the ratio of lignin sulfonate to naphthalene formaldehyde condensate sulfonate is in the range of from about 10:90 to 90:10 at 100% actives concentration.

8. The process of claim 7 wherein the ratio of lignin sulfonate to naphthalene formaldehyde condensate sulfonate is in the range of from about 25:75 to 75:25 at 100% actives concentration.
